(19) United States
(12) Patent Application Publication
(10) Pub. No.: US 2005/0094057 A1
(43) Pub. Date: May 5, 2005

(54) Light guide plate for reducing bump like

(76) Inventors: Ming-Chuan Lin, Taichung (TW); Chin-Liaong Chen, Kaohsiung (TW); Lung-Hui Wang, Taichung County (TW)

Correspondence Address: BIRCH STEWART KOLASCH & BIRCH, PO BOX 747, FALLS CHURCH, VA, 22040-0747, US

(21) Appl. No.: 10/694,787

(22) Filed: Oct. 29, 2003

(51) Int. Cl. G02F 1/1335

(52) U.S. Cl. 349/65

(57) ABSTRACT

A light guide plate for eliminating Bump like phenomenon on LCD monitors includes a LCD panel mounting onto a light guide plate to form a gap therebwteens to house particles so that the LCD panel is not compressed by the particles and Bump like phenomenon may be prevented from occurring on-the LCD panel.

### FIELD OF THE INVENTION

The present invention relates to light guide plates and particularly to a light guide plOate for eliminating bump like phenomenon on liquid crystal display (LCD) devices.

### BACKGROUND OF THE INVENTION

LCD monitor is thin and light, thus is the widely used in communication applications. The LCD monitor mainly consists of a LCD panel, light guide plate and back light source. The LCD panel includes a directional liquid crystal film. The uniformity and directional property of the liquid crystal film affects the display quality of the LCD monitor. Referring to FIGS. 1 and 2, when a LCD panel 1 and a light guide plate 2 are assembled, if there are particles 3 existed therebetween, the particles will be compressed by the light guide plate 2 to form bulged spots on the surface of the LCD panel 1. As a result, directional property of the liquid crystals in some areas of the LCD panel 1 suffers. And a small black dot will appear on the LCD panel that is generally called “Bump like” 4.

Referring to FIGS. 3 and 4, to remedy the aforesaid problem, a conventional technique being adopted is to place a spacer 5 on the periphery of the contact surface between the LCD panel 1 and the light guide plate 2. The spacer 5 forms a gap 6 between the LCD panel 1 and the light guide plate 2 to contain particles 3 so that the LCD panel 1 will not be compressed by the particles 3 and Bump Like may be prevented from occurring. In practice, an adhesive tape of a selected thickness is used as the spacer 5 for bonding on the light guide plate 2. The bonding spacer 5 should not mask the display area of the LCD panel 1. Hence the spacer 5 is bonded on the light guide plate 2 outside the display area, and the LCD panel 1 is in contact with the light guide plate 2 through the spacer 5. As a result, there is the gap 6 in the display area of the light guide plate 2 and LCD panel 1 to prevent Bump Like from occurring on the LCD panel 1.

Although the technique set forth above can eliminate the Bump like phenomenon for LCD panel, it requires a great amount of labor and resources, thus is not suitable for mass production.

### SUMMARY OF THE INVENTION

In view of the aforesaid disadvantages, the object of the invention is to provide a light guide plate structure to resolve the Bump like phenomenon on the LCD device and facilitate mass production.

The light guide plate structure according to the invention has a recess surface in the center of a holding plane of the light guide plate. The holding plane has an elevation difference so that the LCD panel may be mounted thereon to form a gap with the light guide plate for holding particles, thereby Bump like may be prevented from occurring on the LCD panel.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic sectional view of a conventional LCD panel with Bump like phenomenon.

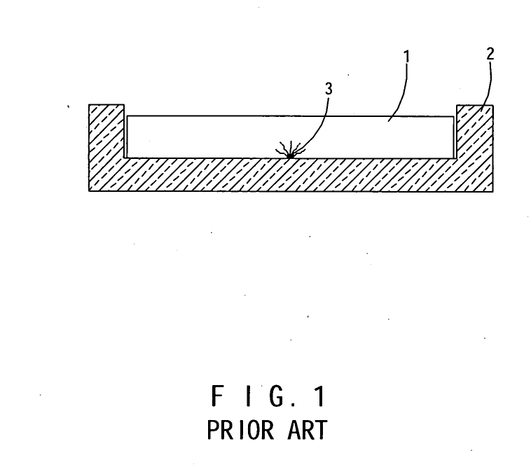

FIG. 2 is a schematic front view of a conventional LCD panel with Bump like phenomenon.

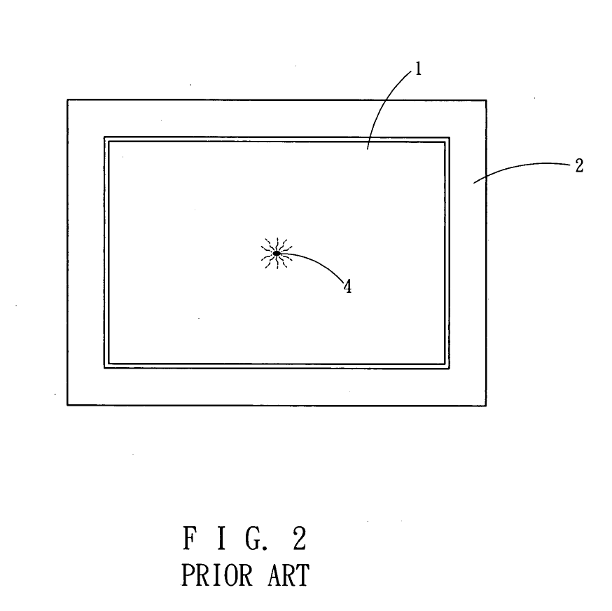

FIG. 3 is an exploded view of a conventional LCD panel.

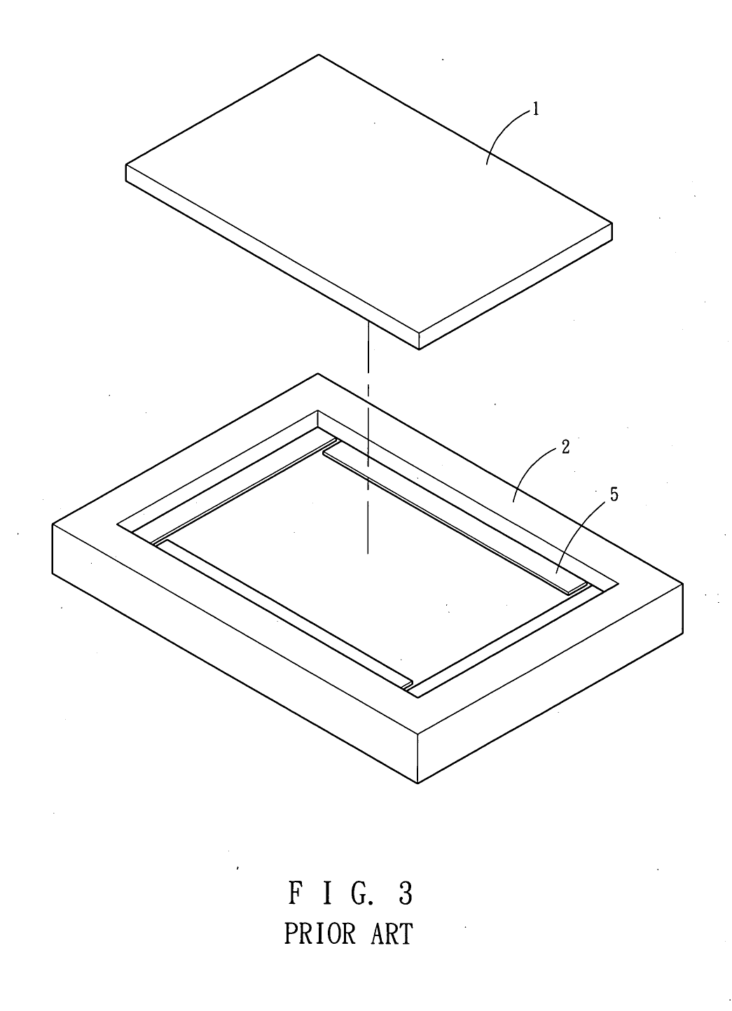

FIG. 4 is a sectional view of a conventional LCD.

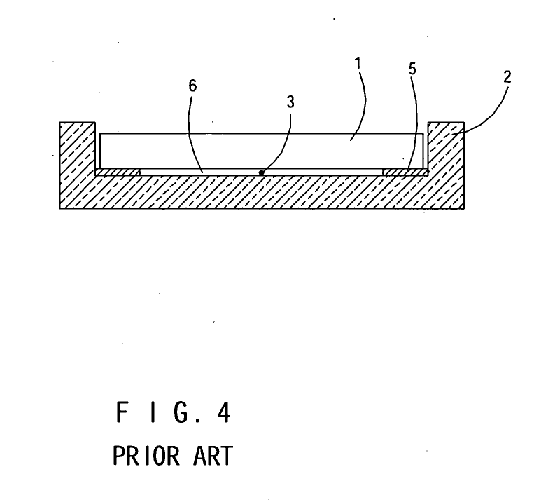

FIG. 5 is an exploded view of the present invention.

FIG. 6 is a sectional view of the present invention.

### DETAILED DESCRIPTION OF THE PREFERRED EMBODIMENT

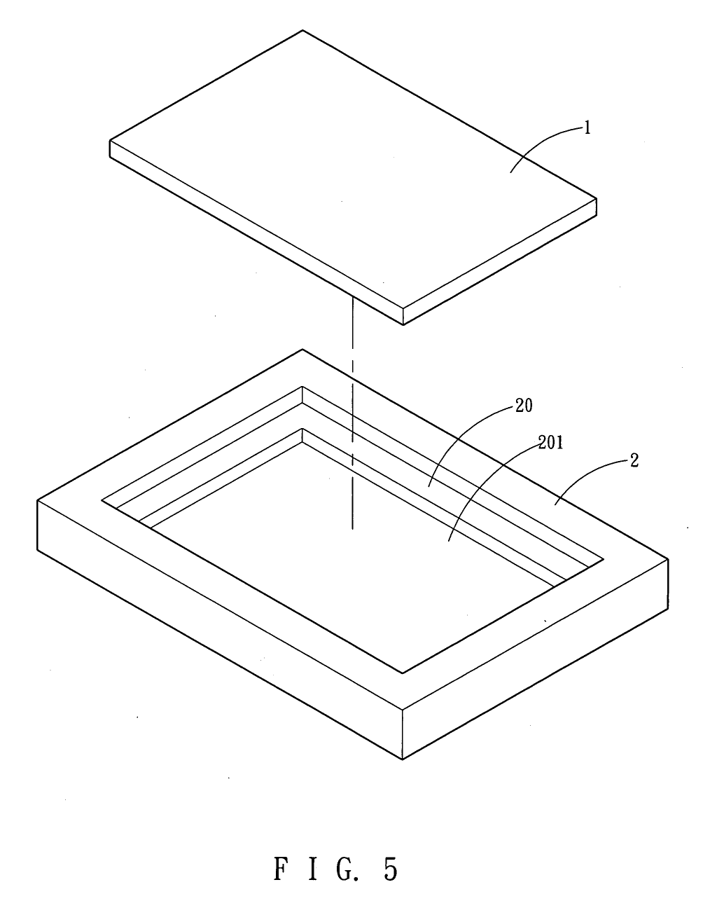

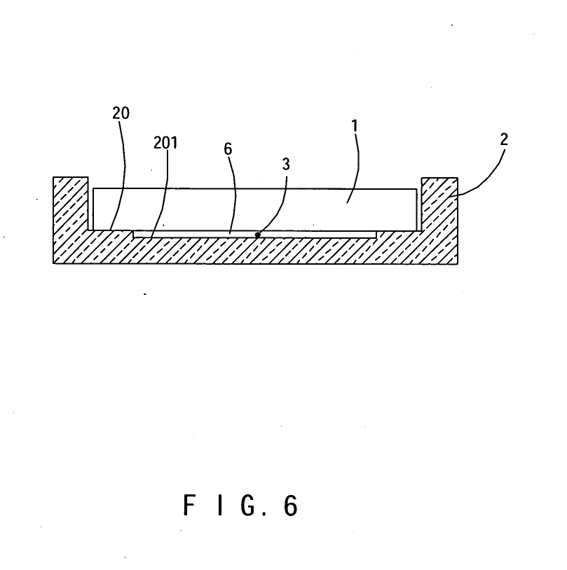

Please referring to FIG. 5 and 6, the light guide plate 2 according to the invention has a holding plane 20 for holding a LCD panel 1. The holding plane 20 has a recess surface 201 in the center to form an elevation difference with the holding plane 20. Thus when the LCD panel 1 is mounted onto the holding plane 20, the elevation difference forms a gap 6 between the LCD panel 1 and the light guide plate 2. The size of the gap 6 may be set by controlling the depth of the recess surface 201, preferably between 0.05 mm and 0.1 mm. The gap 6 may contain particles 3 without compressing the LCD panel 1, thus can eliminate the Bump like on the LCD panel 1.

Moreover, the area covered by the recess surface 201 is greater than the display area of the LCD panel 1. Namely, the display area of the LCD panel 1 is covered by the recess surface 201 so that the gap 6 exists between the light guide plate 2 and all of the display area of the LCD panel 1 to prevent Bump like from occurring on the display area of the LCD panel 1. By means of the structural design of the light guide plate 2 set forth above, the gap 6 is formed to house the particles 3 thereby eliminate the Bump like problem. Compared with conventional techniques, the invention can achieve the same function without consuming more materials, and is suitable for mass production. Thus it offers a significant improvement over the conventional techniques.

1. A light guide plate for improving bump like phenomenon on LCD monitors comprising a light guide plate and a LCD panel;
wherein the light guide plate has a housing plane for holding the LCD panel, the housing plane having a different elevation to form a gap between the LCD panel and the light guide plate.

2. The light guide plate for reducing bump like according to claim 1, wherein said housing plane has a recess surface in the center to form said different elevation.

3. The light guide plate for reducing bump like according to claim 2, wherein said recess surface covers the display area of said LCD panel.

4. The light guide plate for reducing bump like according to claim 1, wherein said gap ranges from 0.05 mm to 0.1 mm.
